(19) United States
(12) Patent Application Publication
(10) Pub. No.: US 2026/0016377 A1
(43) Pub. Date: Jan. 15, 2026

(54) SYSTEM FOR ABSORBING GAS FROM A GROUND SOURCE USING A SORBENT

(71) Applicants: The United States of America, as Represented by the Secretary of Agriculture, Washington, DC (US); E-FLUX, FORT COLLINS, CO (US)

(72) Inventors: STEPHEN J. DEL GROSSO, FORT COLLINS, CO (US); JORGE A. DELGADO, FORT COLLINS, CO (US); JULIO A. ZIMBRON, FORT COLLINS, CO (US)

(21) Appl. No.: 18/772,411

(22) Filed: Jul. 15, 2024

(51) Int. Cl. G01N 1/22; B01D 53/04; G01N 1/24

(52) U.S. Cl. CPC G01N 1/2294; B01D 53/0415; B01D 2257/402; B01D 2257/504; G01N 2001/247

(57) ABSTRACT

Apparatus, systems, and methods for absorbing gas and measuring gas fluxes are disclosed. This disclosure relates to an apparatus for absorbing a gas, the apparatus comprising a cartridge, the cartridge comprising a housing having a top end opposite a bottom end, a first gas absorbing material disposed within the housing, a second gas absorbing material disposed within the housing, a gas porous separation layer disposed between the first gas absorbing material and the second gas absorbing material, and a top end cap, wherein the top end is capable of forming a gas-tight coupling with the top end cap. A tube may be coupled to the cartridge to transfer a gas sample from a syringe to the cartridge by a syringe pump, where the gas sample is absorbed by a gas absorbing material. The cartridge may be in gaseous communication with a chamber to receive the gas sample.

### FIELD

The disclosed subject matter relates generally to apparatus, systems, and methods for absorbing a gas from a ground source. Specifically, the subject matter described herein relates to apparatus, systems, and methods for absorbing gas and measuring gas fluxes from soil using a sorbent.

### BACKGROUND

Nitrous oxide (N₂O) is an important greenhouse gas (GHG) approximately 265 times stronger than carbon dioxide (CO₂) and the primary anthropogenic contributor to stratospheric ozone depletion (U.S. EPA, 2023; Ravishankara 2009). On average, more than 1% of agricultural nitrogen fertilizer is transformed to N₂O in the soil and released back into the atmosphere, constituting one of the largest GHG contributions from U.S. agriculture footprint (U.S. EPA, 2023).

Measurements for N₂O emissions from soils are obtained by multiple techniques, broadly classified as “bottom-up” (typically based on soil surface measurements and/or derived emission factors) or “top-down” (typically involving inversion models and atmospheric gas measurements from instrumented micrometeorological towers). Top-down measurements are more applicable to larger scales and are resource- and expertise-intensive, while bottom-up measurements are comparatively easier to implement and generally more applicable to smaller scale agricultural plots, but require labor and instrumental resources. Although these approaches often showed poor agreement in earlier comparisons (e.g., Griffis et al. 2013), more recent analysis are consistent especially when using bottom-up methods based on plant-soil system simulation models (Xu et al. 2021; Del Grosso et al. 2022).

The most common bottom-up measurement technique (and a consensus standard) is the chamber method, in which grab gas samples from the chamber headspace are taken at variable times after chamber closure then analyzed for concentration using gas chromatography (Parkin et al. 2003). Although measurement protocols typically recommend a sampling frequency of at least twice per week (e.g., Barton et al. 2015), reported studies often deploy lower sampling frequencies due to resource constraints. Chamber methodology limitations include high instrumentation setup costs, high labor requirements to collect and process many field samples, limited simultaneous measurements at different locations due to hardware or personnel availability, among others. As a result, presently, accurate and cost-effective measurements of soil gas N₂O flux using chamber methodology often exceed the capabilities and resources of most practitioners and data end-users.

There is an interest in the sampling of gases emitted from a sub-surface source for a variety of reasons. For example, there is interest in the sampling of greenhouse gases (GHGs) such as carbon dioxide (CO₂) and nitrous oxide (N₂O) that are released from a ground source such as soil. The current problem is related to the traditional method of sampling of gases from a sub-surface source. In a current method gas samples are taken from soil gas chambers by using syringes to hold the gas for analysis. Gas samples collected with syringes have a short holding time and need to be analyzed quickly after collection (typically within a few hours). Therefore, the fields tested and the analysis laboratory must be close to each other to be reachable within this time to be able to process the gas samples adequately and calculate a gas flux from them.

The current state of the art is the traditional use of soil gas chambers (e.g., USDA GRACEnet), where the chamber is deployed for a duration of 30 minutes, and the gas from the chamber is sampled at 0, 15, and 30 minute increments. The samples are gas samples stored in syringes (typically referred to as “grab samples”) that need to be processed shortly after being collected. This traditional methodology is prohibitive for most practitioners, as it requires a local laboratory for the time sensitive grab sample analysis.

Sorbents have been used to absorb gas samples, with some of their main advantages being concentrating large sample volumes and extending sample shelf-life (the time between the sample is taken and its analysis). For example, sorbents are routinely used to assess human exposure to N₂O (Cox and Brown, 1984), field sampling of volatile contaminants (Salim and Gorecki, 2019), and to measure CO₂ field soil gas fluxes (McCoy et al., 2015).

Other systems and methods of sampling soil gases and measuring a gas flux can be found in U.S. Pat. No. 8,714,034 entitled “Gas Flux Measurement Using Traps,” and U.S. Pat. No. 10,816,441 entitled “In Situ Measurement of Soil Fluxes and Related Apparatus, Systems and Methods,” which are each incorporated herein by reference in their entirety.

While the existing systems and methods are useful to a degree, they still suffer from certain limitations. There is a need for a sorbent-based application for soil gas fluxes that might alleviate some of the chamber use limitations to measure soil emissions. For example, there is a need for a sorbed sampling method that enhances sample stability so non-specialized users could collect samples to be run at a distant specialized facility. Therefore, there exists a need in the art for improved systems and methods for absorbing gas and measuring gas fluxes from soil that solve or at least alleviate some or all of these problems.

### SUMMARY OF THE EMBODIMENTS

Apparatus, systems, and methods for absorbing gas and measuring gas fluxes from soil using a sorbent are disclosed and claimed herein.

As described more fully below, the devices and processes of the embodiments disclosed permit improved systems and methods for absorbing gas and measuring gas fluxes from soil using a sorbent. Further aspects, objects, desirable features, and advantages of the apparatus, systems, and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, an apparatus for absorbing a gas is provided, the apparatus comprising a cartridge, the cartridge comprising a housing having a top end opposite a bottom end; a first gas absorbing material disposed within the housing; and a top end cap, wherein the top end of the housing is capable of forming a gas-tight coupling with the top end cap. In some embodiments, the apparatus further comprises a second gas absorbing material disposed within the housing; and wherein the bottom end of the housing has an opening capable of receiving a tube.

In certain embodiments, the bottom end has an opening capable of receiving a tube. In some embodiments, the apparatus further comprises a bottom end cap, wherein the bottom end is capable of forming a gas-tight coupling with the bottom end cap.

In various embodiments, the housing further comprises a first element and a second element, wherein the first element is separable from the second element; wherein the first gas absorbing material is disposed within the first element, and the second gas absorbing material is disposed within the second element. In certain embodiments, the first element has a first element top end and a first element bottom end; the second element has a second element top end and a second element bottom end; wherein the first element bottom end is separably coupled to the second element top end; and wherein the first element bottom end forms a gas-tight coupling to the second element top end. In some embodiments, the first element bottom end is separably coupled to the second element top end by a gas-tight connector, where a top end of the gas-tight connector is coupled to the first element bottom end and a bottom end of the gas-tight connector is coupled to the second element top end.

In certain embodiments, the cartridge has a first gas permeable support layer between the first gas absorbing material and the gas porous separation layer. In various embodiments, the cartridge has a second gas permeable support layer between the second gas absorbing material and the gas porous separation layer. In some embodiments, the second element bottom end has a reducer connector; wherein the reducer connector is capable of receiving a tube; and wherein the reducer connector creates a gas-tight connection between the tube and the second element.

In various embodiments, the first gas absorbing material and the second gas absorbing material are a nitrous oxide sorbent. In some embodiments, the cartridge is made of metal. In certain embodiments, the tube is made of vinyl. In certain embodiments, the separation layer is glass wool. In some embodiments, the apparatus further comprises a cooling element is coupled to the cartridge. In certain embodiments, the tube is nonpermeable. In some embodiments, the cartridge is nonpermeable.

In some embodiments, the apparatus further comprises a syringe, the syringe having a barrel and a plunger, the plunger operable to displace a gas within the barrel; and wherein the syringe is in gaseous communication with the cartridge such that the gas is capable of being transferred from the syringe to the cartridge. In various embodiments, the gas is collected from a ground source. In certain embodiments, the gas sample may be collected from a chamber, where the chamber is in gaseous communication with a ground source. In some embodiments, a syringe may take a gas sample from an outlet of the chamber.

In certain embodiments, the apparatus further comprises a tube, the tube having a first tube end and a second tube end, the first tube end in gaseous communication with the syringe and the second tube end in gaseous communication with the cartridge.

In various embodiments, the apparatus further comprises a syringe pump operably connected to the syringe, wherein the syringe pump is capable of pushing the plunger into the barrel of the syringe to expel the gas from the syringe through the tube and into the cartridge such that the gas is absorbed by the second gas absorbing material; and wherein the syringe pump is capable of expelling the gas from the syringe at a constant rate. In certain embodiments, the pump is capable of supporting a plurality of syringes, and wherein the pump is capable of deploying gas from a plurality of syringes into the cartridge.

In one form, the present disclosure provides a system for absorbing a gas from a ground source, comprising: a chamber having a top portion and a bottom portion, the bottom portion having an opening in one end, the opening exposed to gas emanating from the ground source; a support structure disposed within the chamber; a gas absorbing material supported by the support structure, wherein the gas absorbing material is in gaseous communication with the ground source; and wherein the chamber is sealed from ambient air when the opening of the bottom portion is placed in gaseous communication with the ground source. In some embodiments, the chamber further comprises a fan disposed in the chamber. In certain embodiments, the chamber is made of metal. In certain embodiments, the system measures a gas flux. In some embodiments, the system measures a soil gas flux.

In one form, the present disclosure provides a method for absorbing a gas from a ground source, the method comprising the steps of: collecting a gas in a chamber; sampling the gas in the chamber to form a gas sample; and stabilizing the gas sample to form a stabilized gas sample. In certain embodiments, the method further comprises the step of circulating the gas within the chamber. In some embodiments, the method further comprises the step of cooling the stabilized gas sample. In various embodiments, the method further comprises the step of calculating a gas flux from the stabilized gas sample. In some embodiments, the step of sampling the gas in the chamber to form a gas sample is performed continuously to reduce biases caused by gas accumulation within the chamber. In various embodiments, the step of sampling the gas in the chamber is automated. In certain embodiments, the method measures a gas flux. In some embodiments, the method measures a soil gas flux.

In some embodiments, the gas is sampled from the chamber with a syringe. In certain embodiments, the step of stabilizing the gas sample further comprises transferring the gas sample from the syringe to a cartridge. In various embodiments, the gas sample is transferred from the syringe to a cartridge by a syringe pump wherein the gas sample is absorbed by a sorbent. In some embodiments, the step of stabilizing the gas sample further comprises cooling the sorbent. In certain embodiments, the method includes the step of calculating a gas flux from the sorbent. In some embodiments, the method includes the step of calculating a soil gas flux from the sorbent.

In certain embodiments, sampling the gas comprises absorbing the gas sample with a sorbent in the chamber. In some embodiments, sampling the gas comprises extracting a gas sample from the chamber with a syringe. In some embodiments, stabilizing the gas sample comprises injecting the gas sample from the syringe to a cartridge wherein stabilizing the gas sample comprises injecting the gas sample from the syringe to a cartridge wherein the cartridge comprises a housing having a top end opposite a bottom end; a first gas absorbing material disposed within the housing; a second gas absorbing material disposed within the housing; and a gas porous separation layer disposed between the first gas absorbing material and the second gas absorbing material. In certain embodiments, stabilizing the gas sample comprises placing the sorbent in a cartridge and sealing the cartridge from ambient air. In some embodiments, a fan is disposed in the chamber. In some embodiments, a pump is in gaseous communication with the chamber. In certain embodiments, a cartridge is in gaseous communication with the pump and the chamber, wherein stabilizing the gas sample comprises injecting the gas sample from the syringe to a cartridge wherein the cartridge comprises a housing having a top end opposite a bottom end; and a first gas absorbing material disposed within the housing.

In various embodiments, the sorbent is disposed in the chamber. In some embodiments, the sorbent is disposed in a cartridge, where the cartridge is in gaseous communication with the chamber. In certain embodiments, the syringe has an opening in a first end for introduction of the plunger, and an opening at an opposite end through which the gas is transferred from the barrel. In some embodiments, the tube is nonpermeable. In some embodiments, the cartridge is nonpermeable. In certain embodiments, the chamber is nonpermeable. In various embodiments, the chamber has a top portion having an inlet and an outlet. In some embodiments, the chamber has a gas-tight separable seal between the top portion and the bottom portion. In certain embodiments, the tube is nonpermeable to a gas. In some embodiments, the cartridge is nonpermeable to a gas. In certain embodiments, the chamber is nonpermeable to a gas.

In one form, an apparatus for absorbing a gas is provided, the apparatus comprising a cartridge, the cartridge comprising a housing having a top end opposite a bottom end; a first gas absorbing material disposed within the housing; a second gas absorbing material disposed within the housing; a gas porous separation layer disposed between the first gas absorbing material and the second gas absorbing material; and a top end cap, wherein the top end is capable of forming a gas-tight coupling with the top end cap.

In one form, the present disclosure provides an apparatus for absorbing a gas from a ground source, comprising: a chamber having a bottom portion and top portion, the top portion having an inlet and an outlet; a gas-tight separable seal between the top portion and the bottom portion; a cartridge in gaseous communication with the outlet, the cartridge comprising: a housing, the housing comprising a first element and a second element, wherein the first element is separable from the second element; a first gas absorbing material disposed within the first element; a second gas absorbing material disposed within the second element; and a gas porous separation layer disposed between the first gas absorbing material and the second gas absorbing material. In some embodiments, the apparatus further comprises a pump in gaseous communication to the inlet.

In one form, the present disclosure provides an apparatus for absorbing a gas from a ground source, comprising: a chamber having a bottom portion and top portion; the top portion having an inlet and an outlet; a gas-tight separable seal between the top portion and the bottom portion; a gas absorbing material disposed in the chamber; wherein the gas absorbing material is a nitrous oxide sorbent.

These and other objects, features, aspects, and advantages of the present patent document will become better understood with reference to the following description and accompanying drawings.

### BRIEF DESCRIPTION OF THE DRAWINGS

FIG. 1 illustrates a side cross sectional view of an embodiment of an apparatus for absorbing a gas of the present patent document.

FIG. 2 illustrates a side view of the apparatus for absorbing a gas of the present patent document shown in FIG. 1.

FIG. 3 illustrates an exploded view of the apparatus for absorbing a gas of the present patent document shown in FIG. 1.

FIG. 4 illustrates a side cross sectional view of another embodiment of an apparatus for absorbing a gas of the present patent document.

FIG. 5 illustrates a side cross sectional view of another embodiment of the apparatus for absorbing a gas of the present patent document.

FIG. 6 illustrates a side view of the apparatus for absorbing a gas of the present patent document shown in FIG. 4.

FIG. 7 illustrates a side view of the apparatus for absorbing a gas of the present patent document shown in FIG. 5.

FIG. 8 illustrates an exploded view of the apparatus for absorbing a gas of the present patent document shown in FIG. 4.

FIG. 9 illustrates a side view of another embodiment of an apparatus for absorbing a gas of the present patent document.

FIG. 10a illustrates a side view of another embodiment of an apparatus for absorbing a gas of the present patent document.

FIG. 10b illustrates an exploded side view of the apparatus for absorbing a gas of the present patent document shown in FIG. 10a.

FIG. 11 illustrates a side view of another embodiment of an apparatus for absorbing a gas of the present patent document.

FIG. 12 illustrates a side view of another embodiment of an apparatus for absorbing a gas of the present patent document.

FIG. 13 illustrates a process for absorbing a gas in accordance with a preferred embodiment of the present patent document.

FIG. 14a is a graph of single sample results for soil gas concentrations in parts per billion (ppb) at 30 minutes of a chamber deployment.

FIG. 14b is a graph of the corresponding soil gas fluxes (μgN/m²/hr) of FIG. 14a.

FIG. 15a is a graph of pooled sample results for soil gas concentrations (ppb) at 30 minutes of chamber deployment compared to average grab sample results (ppb).

FIG. 15b is a graph of the resulting soil gas fluxes from both techniques from FIG. 15a.

FIG. 16 is a comparison of grab sampling results and sorbent-based sampling results.

Note that assemblies/systems in some of the figures may contain multiple examples of essentially the same component. For simplicity and clarity, only a small number of the example components may be identified with a reference number. Unless otherwise specified, other non-referenced components with essentially the same structure as the exemplary component should be considered to be identified by the same reference number as the exemplary component. Further, unless specifically indicated otherwise, drawing components may or may not be shown to scale.

### DETAILED DESCRIPTION OF PREFERRED EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

In accordance with the present disclosure, improved apparatus, systems, and methods for absorbing gas and measuring gas fluxes from soil are disclosed which address, or at least ameliorate one or more of the problems of existing designs.

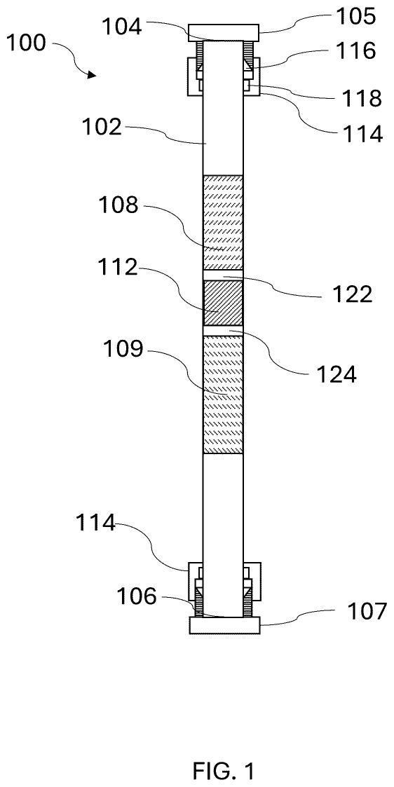

FIG. 1 illustrates a side cross sectional view of an embodiment of an apparatus for absorbing a gas of the present patent document. Referring to FIG. 1, there is shown a side cross sectional view of an embodiment of a cartridge 100 of the present patent document. The cartridge 100 may be referred to as an apparatus for absorbing a gas. In certain embodiments, the cartridge 100 comprises a housing 102 having a top end 104 opposite a bottom end 106. A first gas absorbing material 108 may be disposed within the housing 102. A second gas absorbing material 109 may be disposed within the housing 102. A gas porous separation layer 112 may be disposed between the first gas absorbing material 108 and the second gas absorbing material 109.

In various embodiments, the cartridge 100 may have a top end cap 105, where the top end 104 of the housing 102 is capable of forming a gas-tight coupling with the top end cap 105. The cartridge 100 may have a bottom end cap 107, wherein the bottom end 106 of the housing 102 is capable of forming a gas-tight coupling with the bottom end cap 107. In some embodiments, a gas-tight coupling may be referred to as a gas-tight separable seal.

In some embodiments, the cartridge 100 may have a first gas permeable support layer 122 between the first gas absorbing material 108 and the gas porous separation layer 112. In certain embodiments, the cartridge 100 may have a second gas permeable support layer 124 between the second gas absorbing material 109 and the gas porous separation layer 112. In various embodiments, the gas porous separation layer 112 may be any suitable material, including, but not limited to, wool or glass wool. In various embodiments, the gas permeable support layers (122, 124) may be any suitable material, including, but not limited to, a polymer mesh or a metal mesh.

In some embodiments, the first gas absorbing material 108 and the second gas absorbing material 109 may be carbon dioxide (CO₂) sorbents. In other embodiments, other sorbents may be used to absorb other gasses. For example, in some embodiments, the first gas absorbing material 108 and the second gas absorbing material 109 may be nitrous oxide sorbents.

In various embodiments, the top end cap 105 may form a gas-tight seal with the housing 102 by any manner known in the art. As a non-limiting example in the embodiment shown in FIG. 1, the top end cap 105 may be coupled to a nut 114, a ferrule 116, and a rear ferrule 118 to form a compression fitting that creates a gas-tight seal between the top end cap 105 and the housing 102. In other embodiments, other methods known in the art may be used to create a gas-tight seal between the top end cap 105 and the housing 102. In various embodiments, the gas-tight seals may be gas-tight separable seals.

In some embodiments, the bottom end cap 107 may form a gas-tight seal with the housing 102 by any manner known in the art. As a non-limiting example in the embodiment shown in FIG. 1, the bottom end cap 107 may be coupled to a nut 114, a ferrule 116, and a rear ferrule 118 to form a compression fitting that creates a gas-tight seal between the bottom end cap 107 and the housing 102. In other embodiments, other methods known in the art may be used to create a gas-tight seal between the bottom end cap 107 and the housing 102. In various embodiments, the cartridge 100 may be sealed from gas entering or escaping the cartridge 100, so the cartridge 100 may be transported to a laboratory or other facility, where the gas flux may then be calculated by analyzing the gas absorbing material (108, 109).

In various embodiments, a gas may be absorbed from a source such as a ground source. A ground source may be any surface from which a gas can emanate from, including, but not limited to soil, rocks, snow, ice, or water, among others. A ground source may be a surface source or a sub-surface source.

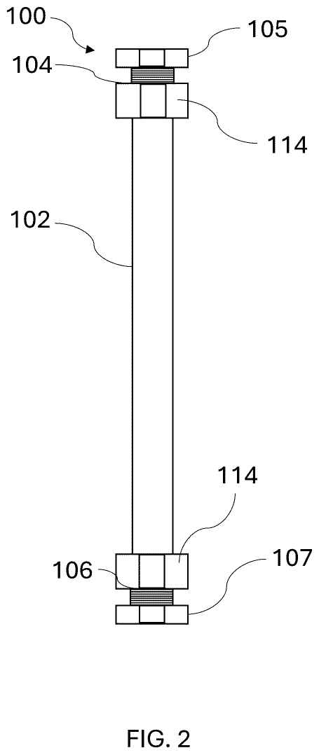

FIG. 2 illustrates a side view of the apparatus for absorbing a gas of the present patent document shown in FIG. 1. Referring to FIG. 2 there is shown a side view of the cartridge 100 of the present patent document shown in FIG. 1. In FIG. 2 the cartridge 100 is shown having a housing 102, where the housing 102 forms a gas-tight seal at the top end 104 with the top end cap 105 and nut 114. The housing 102 is also capable of forming a gas-tight seal at the bottom end 106 with the bottom end cap 107 and a nut 114.

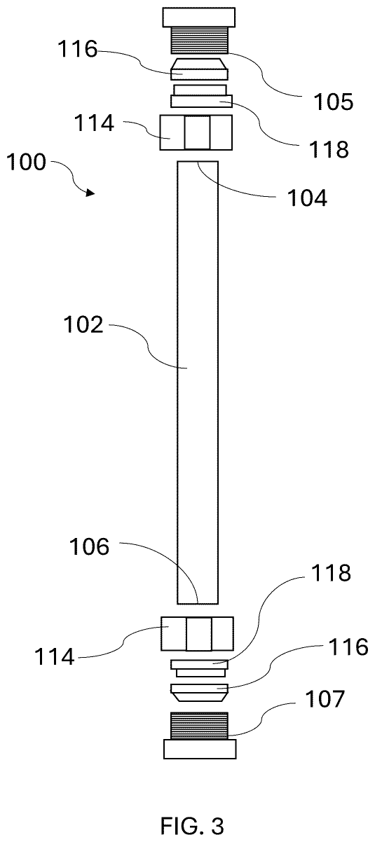

FIG. 3 illustrates an exploded view of the apparatus for absorbing a gas of the present patent document shown in FIG. 1. Referring to FIG. 3 there is shown an exploded view of the cartridge 100 of the present patent document shown in FIG. 1. In some embodiments, the nuts 114 may be coupled to the housing 102 such that the nuts 114 may slide along a length of the housing 102. The nuts 114 may have internal screw threads to screw onto the top end cap 105 or bottom end cap 107 to form a gas-tight seal at the top end 104 or bottom end 106. A nut 114, a ferrule 116, and a rear ferrule 118 may be operatively coupled to form a compression fitting to create a gas-tight seal between the end caps (105, 107) and the housing 102. In other embodiments, other systems or methods known in the art of creating a gas-tight seal may be used to make a gas-tight seal in the top end 104 and the bottom end 106 of the housing 102.

The cartridge 100 may be made of any suitable material, including, but not limited to, metal or plastic. In a preferred non-limiting example, the cartridge 100 may be made of steel. In some embodiments, the cartridge 100 may be nonpermeable to a gas.

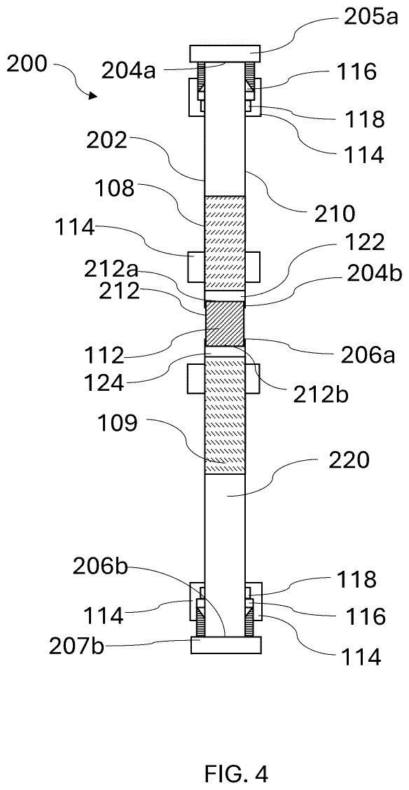

FIG. 4 illustrates a side cross sectional view of an embodiment of an apparatus for absorbing a gas of the present patent document. Referring to FIG. 4, there is shown a side cross sectional view of a preferred embodiment of a cartridge 200 of the present patent document. The cartridge 200 may be referred to as an apparatus for absorbing a gas. In a preferred embodiment, the cartridge 200 has a housing 202, where the housing 202 has a first element 210 and a second element 220, where the first element 210 may be separable from the second element 220. In certain embodiments, the first gas absorbing material 108 may be disposed within the first element 210, and the second gas absorbing material 109 may be disposed within the second element 220. The first element 210 may have a first element top end 204a and a first element bottom end 204b. The second element 220 may have a second element top end 206a and a second element bottom end 206b.

In various embodiments, the first element bottom end 204b may be separably coupled to the second element top end 206a. In certain embodiments, the first element bottom end 204b may be separably coupled to the second element top end 206a by a gas-tight connector 212. The gas-tight connector 212 may have a gas-tight connector top end 212a and a gas-tight connector bottom end 212b, where the gas-tight connector top end 212a may be coupled to the first element bottom end 204b and the gas-tight connector bottom end 212b may be coupled to the second element top end 206a. In some embodiments, the first element 210 may be coupled directly to the second element 220. In other embodiments, the first element 210 may be coupled to the second element 220 by any suitable manner known in the art.

In some embodiments, the cartridge 200 may have a first gas permeable support layer 122 between the first gas absorbing material 108 and the gas porous separation layer 112. In certain embodiments, the cartridge 200 may have a second gas permeable support layer 124 between the second gas absorbing material 109 and the gas porous separation layer 112.

The first element 210 may have a first element top end 204a and a first element bottom end 204b. The first element top end 204a may be capable of forming a gas-tight coupling with a first element top end cap 205a. The second element 220 may have a second element top end 206a and a second element bottom end 206b. The second element bottom end 206b may be capable of forming a gas-tight coupling with a second element bottom end cap 207b. In some embodiments, a gas-tight coupling may be referred to as a gas-tight separable seal.

In various embodiments, the first element top end cap 205a may form a gas-tight seal with the first element 210 by any manner known in the art. As a non-limiting example in the embodiment shown in FIG. 4, the first element top end cap 205a may be coupled to a nut 114, a ferrule 116, and a rear ferrule 118 to form a compression fitting that creates a gas-tight seal between the first element top end cap 205a and the first element 210. Other methods known in the art may be used to create a gas-tight seal between the first element top end cap 205a and the first element 210. In other embodiments, any other method known in the art to create a gas-tight seal in the first element top end 204a may be used.

In some embodiments, the second element bottom end cap 207b may form a gas-tight seal with the second element 220 by any manner known in the art. As a non-limiting example in the embodiment shown in FIG. 4, the second element bottom end cap 207b may be coupled to a nut 114, a ferrule 116, and a rear ferrule 118 to form a compression fitting that creates a gas-tight seal between the second element bottom end cap 207b and the second element 220. Other methods known in the art may be used to create a gas-tight seal between the second element bottom end cap 207b and the second element 220. In other embodiments, any other method known in the art to create a gas-tight seal in the second element bottom end 206b may be used.

The cartridge 200 may be made of any suitable material, including, but not limited to, metal or plastic. In a preferred non-limiting example, the cartridge 200 may be made of steel. In some embodiments, the cartridge 200 may be nonpermeable to a gas.

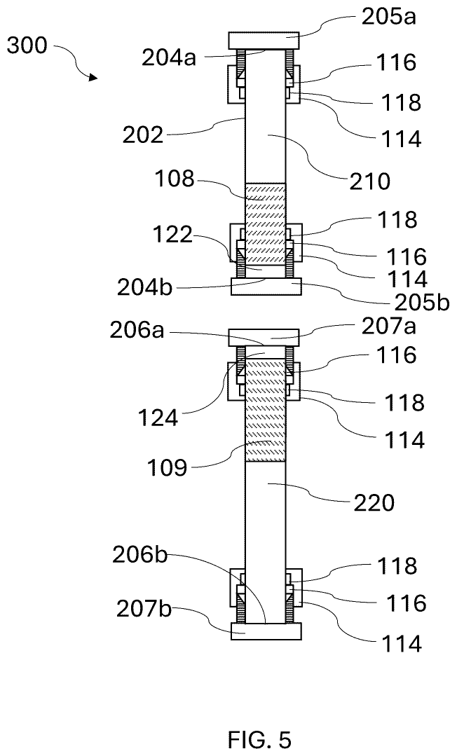

FIG. 5 illustrates a side cross sectional view of another embodiment of an apparatus for absorbing a gas of the present patent document. Referring to FIG. 5 there is shown a side cross sectional view of the cartridge 300 of the present patent document where the two elements (210, 220) are separate. In FIG. 5, the gas-tight connector 212 from FIG. 4 is removed. The first element 210 and the second element 220 may be separated after a gas sample is absorbed by the first gas absorbing material 108 and second gas absorbing material 109. In various embodiments, the elements (210, 220) may be sealed to prevent gas escaping or entering the elements (210, 220). The elements (210, 220) may then be shipped to a laboratory or other facility, where the gas flux may then be calculated by analyzing the gas absorbing material (108, 109). For example, the first element 210 may be sealed at the first element top end 204a by the first element end cap 205a, and sealed at the first element bottom end 204b by the first element bottom end cap 205b for transport to a laboratory where the first gas absorbing material 108 may be analyzed. Similarly, the second element 220 may be sealed at the second element top end 206a by the second element top end cap 207a, and sealed at the second element bottom end 206b by the second element bottom end cap 207b for transport to a laboratory where the second gas absorbing material 109 may be analyzed.

The first element 210 may have a first element bottom end 204b and a first element bottom end cap 205b, where the first element bottom end 204b may be capable of forming a gas-tight coupling with the first element bottom end cap 205b. The second element 220 may have a second element top end 206a and a second element top end cap 207a, where the second element top end 206a may be capable of forming a gas-tight coupling with the second element top end cap 207a. In some embodiments, a gas-tight coupling may be referred to as a gas-tight separable seal.

In some embodiments, when the first element 210 is separated from the second element 220, the first gas permeable support layer 122 may be removed from the first element 210. In other embodiments, when the first element 210 is separated from the second element 220, the first gas permeable support layer 122 may remain inside the first element 210.

In certain embodiments, when the first element 210 is separated from the second element 220, the second gas permeable support layer 124 may be removed from the second element 220. In other embodiments, when the first element 210 is separated from the second element 220, the second gas permeable support layer 124 may remain inside the second element 220.

In various embodiments, the first element bottom end cap 205b may form a gas-tight seal with the first element 210 by any manner known in the art. As a non-limiting example in the embodiment shown in FIG. 5, the first element bottom end cap 205b may be coupled to a nut 114, a ferrule 116, and a rear ferrule 118 to form a compression fitting that creates a gas-tight seal between the first element bottom end cap 205b and the first element 210. Other methods known in the art may be used to create a gas-tight seal between the first element bottom end cap 205b and the first element 210. In other embodiments, any other method known in the art to create a gas-tight seal in the first element bottom end 204b may be used.

In some embodiments, the second element top end cap 207a may form a gas-tight seal with the second element 220 by any manner known in the art. As a non-limiting example in the embodiment shown in FIG. 5, the second element top end cap 207a may be coupled to a nut 114, a ferrule 116, and a rear ferrule 118 to form a compression fitting that creates a gas-tight seal between the second element top end cap 207a and the second element 220. Other methods known in the art may be used to create a gas-tight seal between the second element top end cap 207a and the second element 220. In other embodiments, any other method known in the art to create a gas-tight seal in the second element top end 206a may be used.

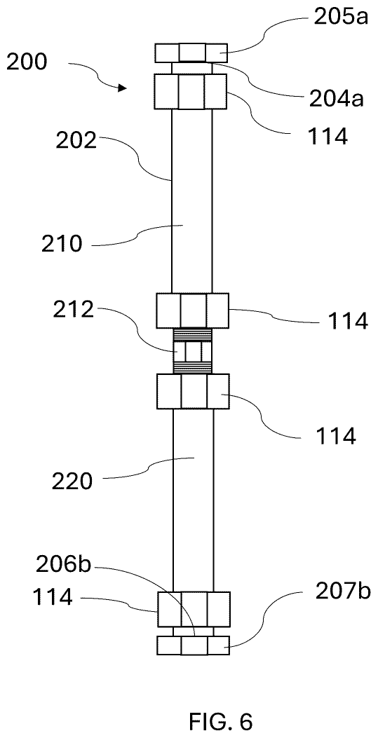

FIG. 6 illustrates a side view of the apparatus for absorbing a gas of the present patent document shown in FIG. 4. Referring to FIG. 6 there is shown a side view of the cartridge 200 of the present patent document shown in FIG. 4. In certain embodiments, the first element 210 may be separably coupled to the second element 220 by a gas-tight connector 212. In some embodiments, nuts 114 may be coupled to the first element 210 such that the nuts 114 may move slidably along a length of the first element 210. In another embodiment, nuts 114 may be coupled to the second element 220 such that the nuts 114 may move slidably along a length of the second element 220. The nuts 114 may have screw threads on an inside surface. The nuts 114 may be sized to receive a portion of the end caps (205a, 207b) such that external screw threads of the end caps (205a, 207b) interlock with internal screw threads of the nuts 114. The nuts 114 may be sized to receive a portion of the gas-tight connector 212 such that external screw threads of the gas-tight connector 212 interlock with internal screw threads of the nuts 114.

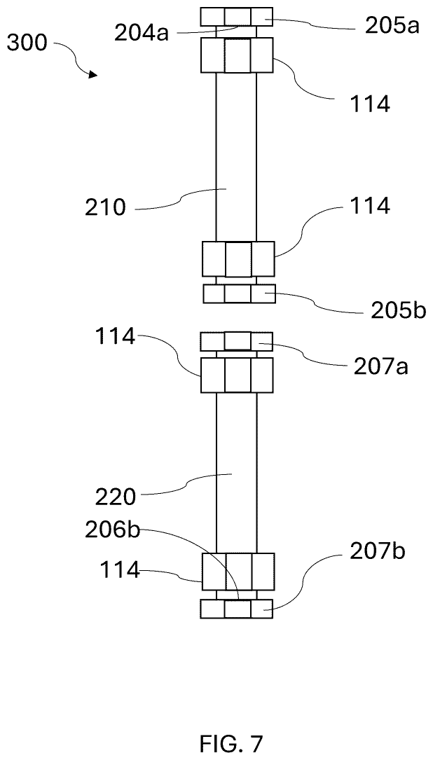

FIG. 7 illustrates a side view of the apparatus for absorbing a gas of the present patent document shown in FIG. 5. Referring to FIG. 7 there is shown a side view of the cartridge 300 of the present patent document shown in FIG. 5 where the two elements (210, 220) are separate. In some embodiments, the nuts 114 may be sized to receive a portion of the end caps (205b, 207a) such that external screw threads of the end caps (205b, 207a) interlock with internal screw threads of the nuts 114.

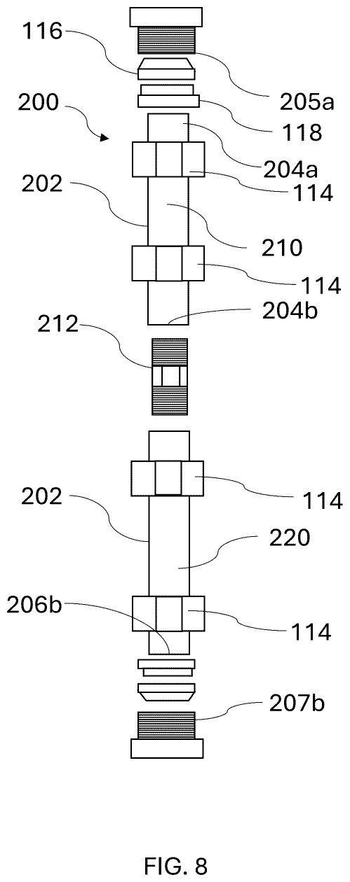

FIG. 8 illustrates an exploded view of the apparatus for absorbing a gas of the present patent document shown in FIG. 4. Referring to FIG. 8 there is shown an exploded view of the cartridge 200 of the present patent document shown in FIG. 4. In certain embodiments, the nuts 114 may be coupled to the housing 202 such that the nuts 114 may slide along the length of the housing 202. A nut 114, a ferrule 116, and a rear ferrule 118 may be operatively coupled to form a compression fitting to create a gas-tight seal between the end caps (205a, 207b) and the housing 202. In other embodiments, other systems or methods known in the art of creating a gas-tight seal may be used to make a gas-tight seal in the first element top end 204a and the second element bottom end 206b of the housing 202.

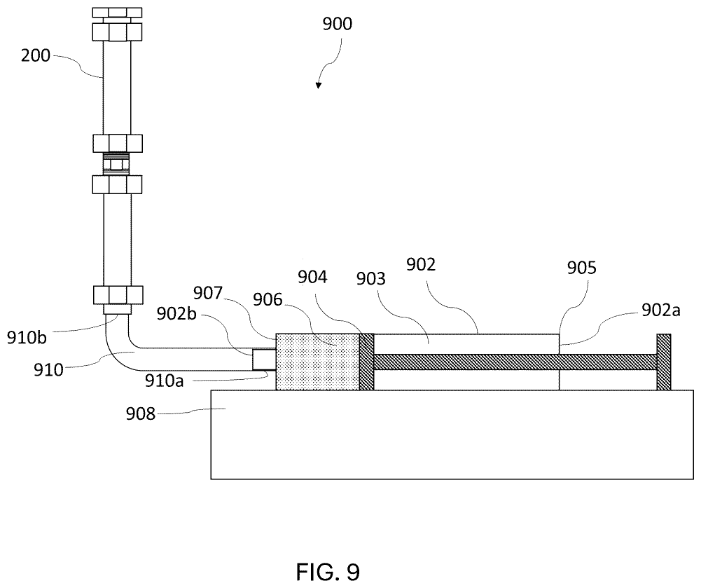

FIG. 9 illustrates a side view of an embodiment of an apparatus for absorbing a gas of the present patent document. Referring to FIG. 9 there is shown a side view of an embodiment of an apparatus 900 for absorbing a gas of the present patent document. In various embodiments, the apparatus 900 may have a syringe 902, where the syringe 902 has a barrel 903 and a plunger 904, where the plunger 904 is operable to displace a gas 906 within the barrel 903. The syringe 902 may be in gaseous communication with the cartridge 200 such that a gas 906 may be transferred from the syringe 902 to the cartridge 200. In some embodiments, the syringe 902 may be any syringe known in the art. In various embodiments, the syringe 902 may be any device capable of dispensing a gas 906. The syringe 902 may have a first opening 902a in a syringe first end 905 for introduction of the plunger 904, and a second opening 902b at a syringe second end 907 through which the gas 906 is transferred from the barrel 903.

In some embodiment, the apparatus 900 may have a tube 910, the tube 910 may have a first tube end 910a and a second tube end 910b, where the first tube end 910a may be in gaseous communication with the syringe 902 and the second tube end 910b may be in gaseous communication with the cartridge 200. In FIG. 9, the cartridge 200 is shown without a second element bottom end cap 207b (as see in the cartridge 200 in FIG. 6). In other embodiments (not shown), the cartridge 200 may be replaced by the cartridge 100. In some embodiments, the syringe second end 907 may be inserted into the tube 910. In other embodiments, the tube 910 may be inserted into the syringe second end 907. In other embodiments, the syringe 902 may be coupled to the tube 910 by any suitable method known in the art.

In some embodiments, the tube 910 may be sized to fit within the cartridge 200 to create a gas-tight seal between the tube 910 and the cartridge 200. In other embodiments (not shown), a connector such as a barbed fitting or reducer connector may be used to create a gas-tight seal between the tube 910 and the cartridge 200.

The apparatus 900 may have a syringe pump 908 operably connected to the syringe 902, where the syringe pump 908 may be capable of pushing the plunger 904 into the barrel 903 of the syringe 902 to expel the gas 906 from the syringe 902 through the tube 910 and into the cartridge 200 such that the gas 906 may be absorbed by a gas absorbing material. In some embodiments, the gas absorbing material may be a sorbent. The syringe pump 908 may be capable of expelling the gas 906 from the syringe 902 at a constant rate.

The syringe 902 may be made of any suitable material, including, but not limited to, metal or plastic. In some preferred non-limiting examples, the syringe 902 may be made of vinyl or polyvinyl chloride (PVC). In certain embodiments, the syringe 902 may be nonpermeable to a gas.

The tube 910 may be made of any suitable material, including, but not limited to, metal or plastic. In some preferred non-limiting examples, the tube 910 may be made of vinyl or PVC. In certain embodiments, the tube 910 may be nonpermeable to a gas.

In various embodiments, the syringe pump 908 may be any syringe pump known in the art. In certain embodiments, the syringe pump 908 may be any device capable of dispensing a gas from a syringe 902.

The syringe pump 908 may be capable of supporting a plurality of syringes 902. In such embodiments, the syringe pump 908 may be capable of deploying gas from a plurality of syringes 902 into a cartridge 200.

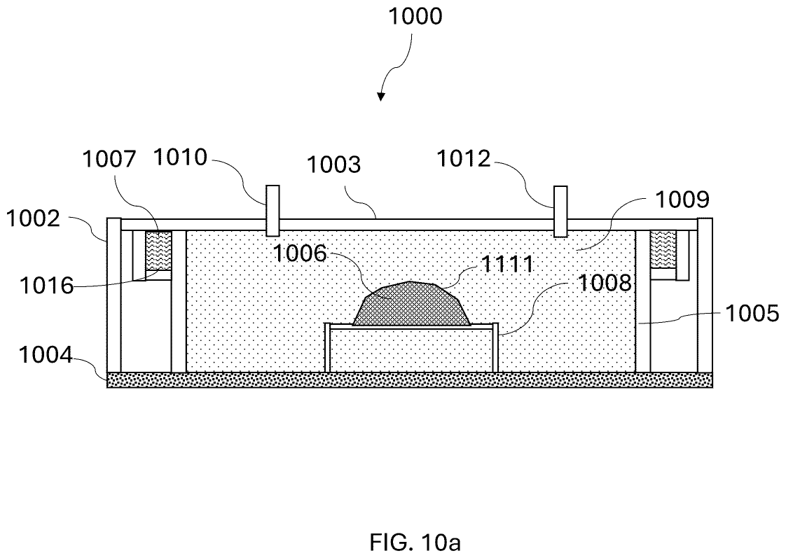

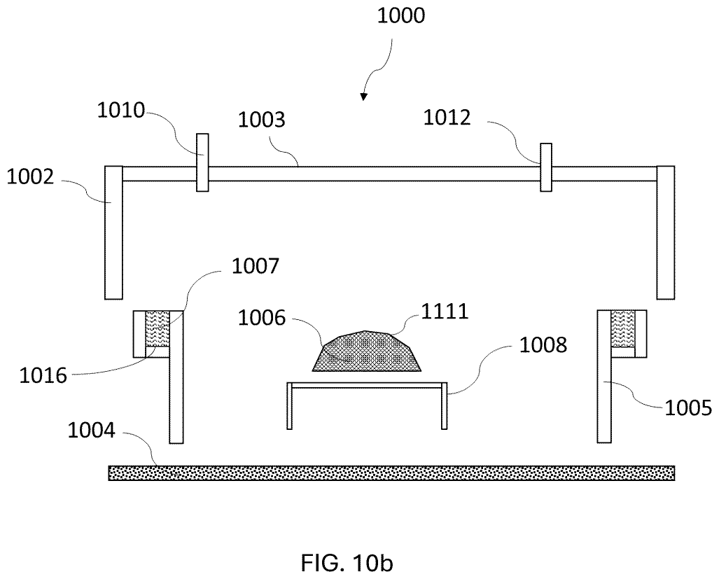

In an embodiment of the apparatus 900, the syringe 902 may expel the gas 906 from the syringe 902 by depressing the plunger 904. The gas 906 may then travel through the second opening 902b at the syringe second end 907 into the tube 910 and into the cartridge 200, where the gas 906 may be absorbed by the gas absorbing material (108, 109 seen in FIG. 4). In other embodiments, the syringe 902 may be any suitable container capable of holding a gas sample. In other embodiments, the syringe pump 908 may be any suitable device capable of expelling a gas sample from a holding container into a cartridge (100, 200). In some embodiments, the gas 906 may be referred to as a gas sample. In various embodiments, the gas sample may be collected from a ground source. In certain embodiments, the gas sample may be collected from a chamber, where the chamber is in gaseous communication with a ground source (see e.g. FIG. 10a). In some embodiments, a syringe may take a gas sample from an outlet of the chamber.

FIG. 10a illustrates a side view of another embodiment of an apparatus for absorbing a gas of the present patent document, where a sorbent is disposed in a chamber. Referring to FIG. 10a there is shown a side view of another embodiment of an apparatus 1000 for absorbing a gas of the present patent document, where a gas absorbing material 1006 is disposed in a chamber 1002. The apparatus 1000 may have a chamber 1002 having a top portion 1003 and a bottom portion 1005 where the bottom portion 1005 may have an end open to a surface 1004. The surface 1004 may be soil. The surface 1004 may be a surface that may be emitting gasses from a sub-surface location. A support stand 1008 may be disposed within the chamber 1002. A gas absorbing material 1006 may be disposed in the chamber 1002, where the gas absorbing material 1006 may be disposed on the support stand 1008. The top portion 1003 of the chamber 1002 may have an inlet 1010 and an outlet 1012. The chamber 1002 may be sealed from the ambient air. In some embodiments, the inlet 1010 and an outlet 1012 may be one-way valves. The chamber may have a gas-tight separable seal between the top portion 1003 and the bottom portion 1005. The gas absorbing material 1006 may absorb a gas 1009 in the chamber 1002. In some embodiments, the gas absorbing material 1006 may be placed inside of a mesh bag 1111. In some embodiments, the mesh bag 1111 may have an opening (not shown) such that the sorbent is further exposed to the gas 1009 in the chamber 1002. In some embodiments, the gas absorbing material 1006 may be a nitrous oxide sorbent. In other embodiments, other sorbents may be used to absorb other gasses. For example, in some embodiments, the gas absorbing material 1006 may be a carbon dioxide (CO₂) sorbent. The embodiment shown in FIG. 10a may be referred to as a passive collection embodiment. In some embodiments, a gas-tight separable seal may be referred to as a gas-tight coupling.

The chamber 1002 may be sealed from the ambient air. The chamber may have a gas-tight separable seal between the top portion 1003 and the bottom portion 1005. The chamber 1002 may be sealed from the ambient air by a seal formed between the top portion 1003 and the bottom portion 1005. The bottom portion 1005 may have a channel 1016 containing a liquid 1007 to form a seal between the top portion 1003 and the bottom portion 1005. In some embodiments, the liquid 1007 may be water.

The chamber 1002 may be made of any suitable material, including, but not limited to, metal or plastic. In a non-limiting example, the chamber 1002 may be made of steel. In some embodiments, the chamber 1002 may be nonpermeable to a gas.

FIG. 10b illustrates an exploded side view of the apparatus for absorbing a gas of the present patent document shown in FIG. 10a. Referring to FIG. 10b there is shown an exploded side view of another embodiment of an apparatus 1000 for absorbing a gas of the present patent document shown in FIG. 10a. A gas absorbing material 1006 may be disposed on a support stand 1008 in a chamber 1002. The support stand 1008 may be disposed on the ground or on outside surface 1004. The gas absorbing material 1006 may be a sorbent. The ground or outside surface 1004 may be any surface from which a gas can emanate from, including, but not limited to, soil, rocks, snow, ice, or water, among others.

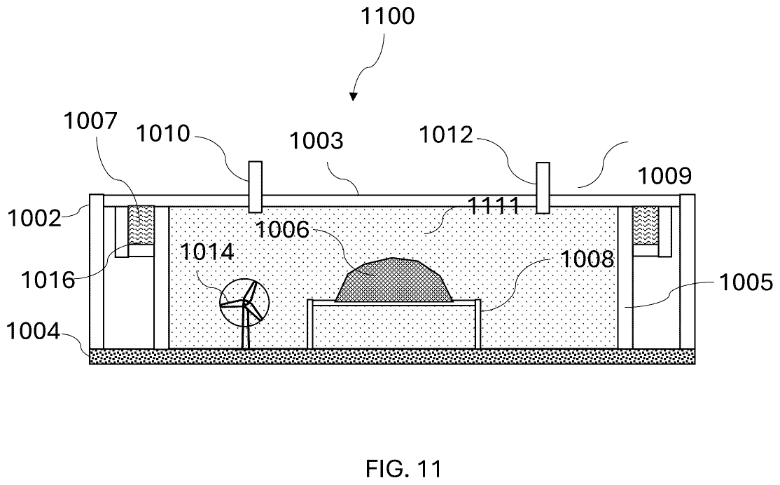

FIG. 11 illustrates a side view of another embodiment of an apparatus for absorbing a gas of the present patent document, where a fan is disposed in the chamber. Referring to FIG. 11 there is shown a side view of another embodiment of an apparatus 1100 for absorbing a gas of the present patent document, where a fan 1014 is disposed in the chamber 1002. In an apparatus 1100 for absorbing a gas, a fan 1014 may be disposed in the chamber 1002, where the fan 1014 may circulate a gas 1009 in the chamber 1002. An embodiment with a fan 1014 may be referred to as a semi-active embodiment.

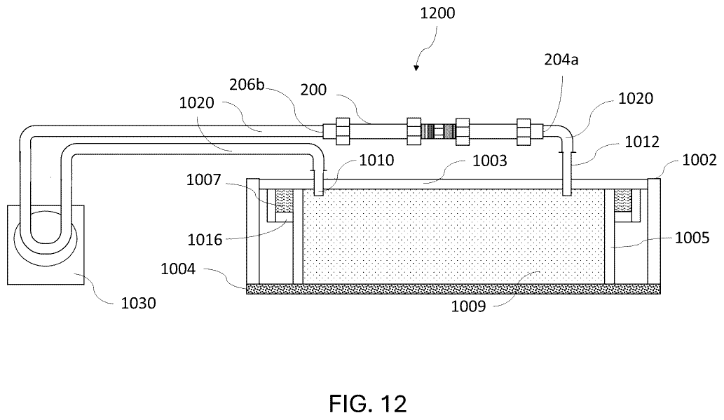

FIG. 12 illustrates a side view of another embodiment of an apparatus for absorbing a gas of the present patent document. Referring to FIG. 12 there is shown a side view of another embodiment of an apparatus 1200 for absorbing a gas where a pump 1030 is operatively coupled to the chamber 1002.

An apparatus 1200 for absorbing a gas may have a chamber 1002 having a top portion 1003 and a bottom portion 1005, where top portion 1003 may have an inlet 1010 and an outlet 1012. The chamber 1002 may be sealed from the ambient air. The chamber may have a gas-tight separable seal between the top portion 1003 and the bottom portion 1005. The chamber 1002 may be sealed from the ambient air by a seal formed between the top portion 1003 and the bottom portion 1005. The bottom portion 1005 may have a channel 1016 containing a liquid 1007 to form a seal between the top portion 1003 and the bottom portion 1005. In some embodiments, the liquid 1007 may be water.

The apparatus 1200 may have a cartridge 200 in gaseous communication with the chamber 1002. In some embodiments, the cartridge 200 may be in gaseous communication with the chamber 1002 through the outlet 1012. The apparatus 1200 may have a pump 1030 in gaseous communication to the inlet 1010. In certain embodiments, the pump 1030 may be in gaseous communication with the cartridge 200 and the chamber 1002. In other embodiments (not shown), the cartridge 200 may be replaced by the cartridge 100.

In the embodiment shown in FIG. 12 of the apparatus 1200, the chamber 1002 may be coupled to an outlet 1012, the outlet 1012 may be coupled to the tube 1020, and the tube 1020 may be coupled to the bottom end 206b of the cartridge 200. The cartridge 200 may be coupled to a tube 1020 by the top end 204a, where the 1020 may be coupled to the pump 1030. The tube 1020 may be coupled to the chamber 1002 by the inlet 1010.

In some embodiments, the tube 1020 may be sized to fit within the cartridge 200 to create a gas-tight seal between the tube 1020 and the cartridge 200. In other embodiments (not shown), a connector such as a barbed fitting or reducer connector may be used to create a gas-tight seal between the tube 1020 and the cartridge 200. The embodiment of the apparatus 1200 shown in FIG. 12 may be referred to as an active embodiment.

The tube 1020 may be made of any suitable material, including, but not limited to, metal or plastic. In some preferred non-limiting examples, the tube 1020 may be made of vinyl or polyvinyl chloride (PVC). In certain embodiments, the tube 1020 may be nonpermeable to a gas.

In an embodiment of the apparatus 1200, the pump may circulate the gas 1009 collected in the chamber 1002. The pump 1030 may circulate the gas 1009 in the chamber 1002 by pulling the gas 1009 through the outlet 1012 into the tube 1020 and into the cartridge 200. The gas may then be absorbed by the gas absorbing material (108, 109 as seen in FIG. 4). Any remaining gas not yet absorbed may then be recycled through the tube 1020 by the pump 1030 and fed back into the chamber 1002 through the inlet 1010. In various embodiments, once a targeted gas is collected in a cartridge, the cartridge may be sent to a lab for analysis. In some embodiments, once a gas is collected or absorbed by a sorbent in a cartridge, the sorbent may then be analyzed to calculate a gas flux from the stabilized gas sample using methods known in the art of calculating a gas flux from a sorbent.

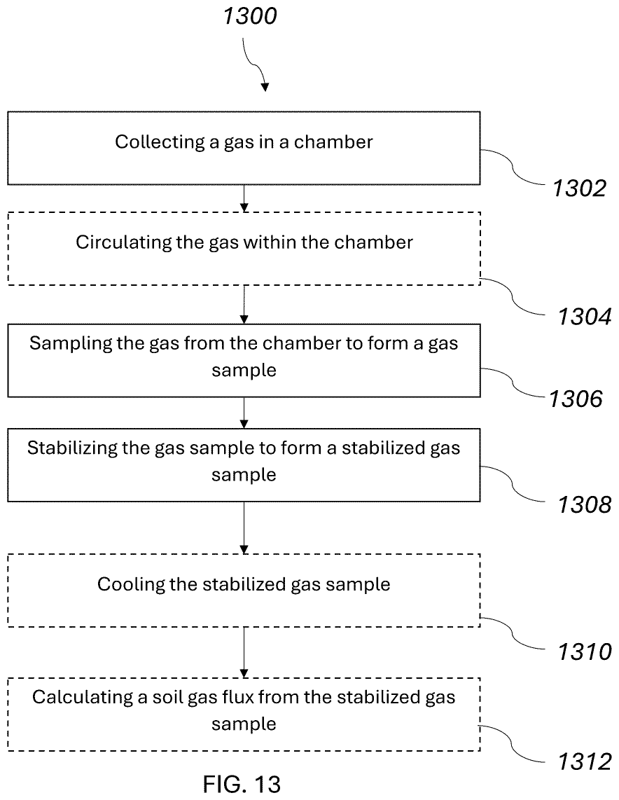

FIG. 13 illustrates a method for absorbing a gas in accordance with a preferred embodiment of the present patent document. Referring to FIG. 13, an embodiment of a method 1300 for absorbing a gas is shown. In method 1300, step 1302 comprises collecting a gas in a chamber. In step 1304, the gas may be circulated within the chamber. Step 1306 comprises sampling the gas from the chamber to form a gas sample. Step 1308 comprises stabilizing the gas sample to form a stabilized gas sample. The gas sample may be stabilized by being absorbed by a sorbent and sealed in a gas-tight cartridge. In step 1310 the stabilized gas sample may be cooled. In step 1312, a soil gas flux may be calculated from the stabilized gas sample. In some embodiments, the sorbent may be in the chamber. In other embodiments, the sorbent may be in gaseous communication with the chamber. In other embodiments, the sorbent may be in a cartridge where the cartridge is in gaseous communication with the chamber.

In some embodiments, the gas is sampled from the chamber with a syringe. In other embodiments, the gas may be sampled from the chamber by any suitable method such as a sealed flask under vacuum. In certain embodiments, the step 1308 of stabilizing the gas sample further comprises transferring the gas sample from the syringe to a cartridge. In various embodiments, the gas sample may be transferred from the syringe to a cartridge by a syringe pump where the gas sample is absorbed by a sorbent. In other embodiments, the gas sample may be transferred from the syringe or sampling method to a cartridge by any suitable method such as a peristaltic pump.

In certain embodiments, the sorbent may be conditioned before use by any current methods known. A conditioned sorbent may then be stored under vacuum (e.g., at 60 mm Hg) in a suitable container before use. Clean, unexposed, conditioned sorbent that is stored in this manner has been shown to be stable for a period of at least weeks. In some embodiments, the sorbent may be stored in a cartridge (100, 200).

In various embodiments, to prepare a cartridge 200, two one-gram (1 g) layers of a conditioned sorbent (first gas absorbing material 108, second gas absorbing material 109) may be packed into 10 cm long stainless steel 0.92 cm outer diameter tubes, closed with compression fitting caps. In certain embodiments, the second gas absorbing material 109 in contact with the gas sample or gas samples may be quantitively analyzed, while the first gas absorbing material 108 may be used as a built-in quality assurance in case of breakthrough in the second gas absorbing material 109. In various embodiments, a soil gas flux from the sorbent-based sample may be calculated using a sample taken after 30 minutes from each chamber.

In some embodiments, after gas samples are collected with a sorbent in a cartridge, the cartridges may be closed and taken to the lab for analysis without further stabilization. In a preferred embodiment, the processing of the cartridges may occur within 3 days of the sample collection. In other embodiments, the processing of the cartridges may occur up to a period of weeks, as samples stabilized with sorbent and stored in airtight containers have been shown to be stable for at least weeks.

In some embodiments, to process the sorbent once in the lab and calculate the N₂O gas flux, the sorbent may be retrieved from the cartridges and placed in 22 ml vials capped with butyl septa. In certain embodiments, both sorbent layers in each cartridge may be analyzed for the gas of interest. In various embodiments, one mL of headspace may be first removed to avoid over pressurization, then one mL of deionized water may be added to the vial to be analyzed. In some embodiments, a small volume (e.g., 0.100 mL) of 500 ppm ethane standard gas may then added to all vials as an internal standard immediately after the water. In certain embodiments, the vials may be heated at 70° C. in a sand bath for 3 minutes and allowed to equilibrate approximately 19-20 hr (e.g., overnight) at room temperature before analysis by Gas Chromatography-Mass Spectrometry (GC-MS), injecting a head space 0.100 mL volume.

In one example, the GC operated isothermally at 50° C., with a total flow rate of 35 mL/min and a split ratio of 12:1, using hydrogen gas (H₂) as carrier gas and an Agilent GS-Carbon plot column (30 m long, 0.32 mm diameter, 3 μm film thickness). In such an example, the MS operated in single ion mode (SIM) for increased sensitivity, collecting ions 28, 30 and 44. In this example, under these conditions N₂O and ethane eluted at 0.79 and 0.89 minutes, respectively. In such an example, after conditioning, the sorbent showed measurable (residual) N₂O. All sorbent-based results may be travel blank corrected, with a travel blank from the same batch. The analysis of the travel-blank corrected cartridges compared to the initial (time zero) concentration is used to estimate the N₂O concentration increased within the chamber. The concentration increase is used to solve the mass balance on the chamber to calculate the flux into it, using conventional methods (as described in the GRACEnet protocols). In some embodiments, the time-zero concentration can be measured on a smaller subset of chamber deployments without significant loss of precision.

The present patent document discloses apparatus, systems, and methods to measure soil gas fluxes by using a sorbent. Embodiments of the present patent document may use sorbents to stabilize gas samples taken from a soil gas chamber. Sorbent-stabilized samples have an extended shelf life, can be more concentrated (which improves analysis), enable additional analysis (such as isotopes) and can reduce the number of samples. The disclosure of this patent document enables direct measurement of soil gas flux data by end-users (e.g., farmers interested in measuring their soil greenhouse gas emissions), rather than assuming that their levels are typical. Data end-users will be able to deploy chambers while the samples can be analyzed by an external, third-party lab. Sorbent-stabilized samples have a holding time of days or weeks, allowing the use of distant labs for analysis. This decouples the use of the flux chamber to the analysis of the samples. In certain embodiments, the disclosure of the present patent document replaces gas sampling with sorbent sampling. However, the apparatus, systems, and methods of the present patent document can be extended to sample multiple chambers using a single sorbent cartridge (to aggregate samples in the field, simplify data handling and reduce the number of samples analyzed), automate the chamber sampling, and/or continuously sorb the gas during sorption to reduce biases caused due to gas accumulation within the chamber (an effect called the chamber effect). This can have additional advantages in cost and measurement error reduction.

The apparatus, systems, and methods of the present patent document may require sorbents appropriate to the gas of interest and use under conditions at which they are compatible with the gas sorbed. Tests have focused on nitrous oxide (N₂O), but the apparatus, systems, and methods of the present patent document may be of general applicability to other soil gases (such as CO₂). The apparatus, systems, and methods of the present patent document may be combined with available sampling equipment (e.g., chambers) and sorbents (e.g., Zeolite 5A for N₂O).

In some embodiments, a validated method of the present patent document, as disclosed herein, that is usable without setting up or managing a lab is an important improvement over existing methods. In certain embodiments, the disclosure of the present patent document improves the stability of the samples using sorbents and allows a reduction of the number of samples that need to be taken. This enables measurements at fields located far away from the lab and reduces lab and personnel costs. Current users of soil gas chambers may be able to reduce personnel and equipment costs required to collect and process fewer, more stable samples. Other potential users, that currently are not able to implement direct soil gas measurements due to cost or infrastructure limitations, may benefit from the disclosure of the present patent document, and become new users. The disclosure of the present patent document has applications to research (for example current scientific users, or nascent carbon credit markets (such as farmers looking for a premium to low GHG emissions crops).

Reference will now be made to an experiment and the results of the experiment. The embodiments, systems, apparatus, and methods disclosed herein are non-limiting examples only.

Here the results are compared with standard soil gas flux chambers based on grab sampling with those of a modified sampling method using the sorbent Zeolite 5A (Z5A), which has been used for N₂O gas sampling.

This experiment tested an adaptation of sorbent-based sampling (using the sorbent Zeolite 5A, or Z5A) to measure soil gas fluxes using the standard chamber method (which normally use grab samples), with the goal to expand the chamber method beyond its current limitations. Both methods were field tested side-by-side in experimental plots in four separate dates. The modified method used a single large (400 mL) sample at the end of the chamber deployment (30 minutes), compared to taking three small (25 mL) grab samples during the same period. Large samples were field-stabilized by sorption. Standard method samples were lab analyzed by gas chromatography and thermal desorption/gas chromatography were used for sorbed samples. Soil gas fluxes were calculated using the measured gas concentrations and the GRACEnet protocols for the standard method and assuming linear increases in concentration for the sorbent method. Gas concentrations measured by both methods at the end of the chamber deployment (30 min) were in close agreement (R²=0.92), with a correlation not significantly different than the ideal 1:1 relationship (α=0.05). Also, calculated soil gas fluxes from sorbed samples were in agreement with those based on grab samples (R²=0.91). Additionally, four-100 mL samples were pooled into a single cartridge to explore the sorbent potential to further reduce the number of samples analyzed. Pooled sample results from four locations correlated well with those of average chamber deployments (R²=0.92 and R²=0.95 for N₂O concentrations and soil gas fluxes, respectively). These results suggest sorbent-based sampling yields soil gas flux data of similar quality to grab sampling methods, with potential advantages of increased sample stability and reduced number of samples.

A successful sorbent-based application for N₂O soil gas fluxes, as disclosed herein, may alleviate some of the chamber use limitations to measure N₂O soil emissions. For example, the sorbed sampling method tested may enhance sample stability so non-specialized users could collect samples to be run at a distant specialized facility.

Materials and methods: Soil gas flux measurements were conducted at 12 locations within plots. To get a wide range of N₂O fluxes, variable nitrogen supplement levels and irrigation were used, as these conditions promote N₂O production. Two different sampling methods were used on each chamber deployment, i) the standard method used by the United States Department of Agriculture (USDA) based on grab samples and ii) a method of the present patent document based on sorbent sampling. Paired results from both sampling methodologies (for nitrous oxide gas concentration and the resulting calculated soil gas flux from concentration measurements) on the same chamber deployment were compared by linear regression methods.

Grab-Sampling: Measurements of nitrous oxide soil gas flux followed USDA methods documented in the USDA-ARS GRACEnet Protocols. The soil gas flux chamber design used has a rectangular area of 78.5 cm×40.5 cm and 10.5 cm high, resulting in a capture area of 0.326 m², and a chamber volume of 34.25 L. Small volume (25 mL) grab (gas) samples were taken from the chamber top though a bulkhead fitting at 0, 15 and 30 minutes after deployment and ran at the local USDA facilities within the same day for a gas chromatography electron capture detector (GC-ECD) to measure their concentration (C_{grab}) in parts per billion (ppb) N₂O. A mass balance around the chamber was solved using the slope of the concentration vs. time plot to calculate the flux on each chamber deployment (Flux_{grab}). The GRACEnet procedures recommend testing if the change in chamber gas concentration is constant in which case linear regression can be used to calculate the flux. If the concentration change is non-linear then the protocol recommends using an alternative gas flux equation.

Sorbent-Based Sampling: After all grab samples were collected, a single 400 mL sample was taken with a large plastic syringe (and the actual sampling time after chamber deployment recorded) for sorbent analysis to estimate gas concentrations (C_{sorb}). The 400 mL gas samples collected in syringes were field sorbed shortly after collection (within 20 minutes) into cartridges containing zeolite 5A (Z5A, 1.6 mm pellets) using a multi-channel syringe pump at a flow rate of 25 mL/min. The sorbent cartridge was cooled during sorption using two 2.5 cm-thick aluminum plates (10 cm×15 cm wide) stored in an ice bath between use.

Sorbent Conditioning: The sorbent was conditioned before use following published procedures. Conditioned sorbent was stored under vacuum (60 mm Hg) before use. Clean, unexposed sorbent stored in this manner (and also stored in 22 mL analysis vials) has been shown to be stable for weeks.

Cartridge Preparation: Two one-gram (1 g) layers of the conditioned sorbent were packed into 10 cm long stainless steel 0.92 cm outer diameter tubes, closed with compression fitting caps. In this embodiment, the first sorbent layer in contact with the gas samples was quantitively analyzed, while the second sorbent layer was used as a built-in quality assurance in case of breakthrough in the first sorbent layer. The N₂O soil fluxes from sorbent-based samples (Flux_{sorb}) were calculated using a single sample taken after 30 minutes from each chamber. The time zero concentration for all replicates in each treatment necessary for sorbent-based flux calculation was measured in one of the replicates only, otherwise following the same procedures used for the sorbent-based sample taken after 30 minutes from deployment.

Sorbed Sample Analysis: After sample sorption, cartridges were closed and taken to the lab for analysis without further stabilization. Processing the cartridges occurred within 3 days of sample collection (although samples stabilized with sorbent and stored in airtight containers have been shown to be stable for weeks). Once in the lab, the sorbent was retrieved from the cartridges and placed in 22 mL vials capped with butyl septa. Both sorbent layers in each cartridge were analyzed for N₂O. One mL of deionized water was added to the vial (after removing 1 mL of headspace to avoid over pressurization). A small volume (0.100 mL) of 500 ppm ethane standard gas was then added to all vials as internal standard immediately after the water. The vials were heated at 70° C. in a sand bath for 3 minutes and allowed to equilibrate 19-20 hr (overnight) at room temperature before analysis by GC-MS, injecting a head space 0.100 mL volume. The GC operated isothermally at 50° C., with a total flow rate of 35 mL/min and a split ratio of 12:1, using H₂ as carrier gas and an Agilent GS-Carbon plot column (30 m long, 0.32 mm diameter, 3 μm film thickness). The MS operated in single ion mode (SIM) for increased sensitivity, collecting ions 28, 30 and 44. Under these conditions N₂O and ethane eluted at 0.79 and 0.89 minutes, respectively. After conditioning, the sorbent showed measurable (residual) N₂O. All sorbent-based results were travel blank corrected (with a travel blank from the same batch).

Field Sampling: Sampling occurred during autumn to minimize temperature limitation on microbial activity that results in N₂O production. Paired measurements of both sampling methodologies were conducted on the same chamber deployment, to minimize sources of variability other than the sample sampling and analysis. The primary goal was to compare both sampling methods on a wide range of N₂O production intensities, so plots were sampled receiving varying amounts of nitrogen (N) fertilizer additions, as fertilizer rate is a primary driver of emission intensity.

Field measurements were conducted each of four days in late September/early October 2023, after supplemental off-season fertilization to obtain a broad range of N₂O emissions. Three fertilization treatment levels consisted of 0, 200 and 400 kg N/Ha in four replicate locations for each level. Each fertilization event was followed by irrigation in all 12 locations (at a rate of 2.5 cm). The first fertilization event occurred on Sep. 26, 2023 (day 0). Due to the prolonged sampling period of over two weeks, a repeat fertilization was repeated 10 days after the first. Sampling occurred at 1, 14, 20 and 21 days after the first fertilization event.

The standard deployment of chambers used by the USDA program uses three 25 mL grab samples at times 0, 15 and 30 minutes after chamber deployment. After all grab samples were collected, a fourth single sample (400 mL) was drawn from the same chamber deployment and stabilized by field concentrating it into a cartridge with sorbent. Lastly, a fifth sample (100 mL) was taken for sorption of all four N treatment replicates (for a total pooled sample volume of 400 mL) into a single sorbent cartridge (pooled sorbent samples) to test the potential of sorption sampling in further reducing the number of field samples. The concentrations of the grab samples (C_{grab}) were used to calculate the soil gas flux for each chamber deployment (Flux_{grab}), while the concentration from the fourth field sorbent sample (C_{sorb}) was used to calculate a sorbent-based soil gas flux (Flux_{sorb}) for comparison. Results from the fifth, pooled sorbed sample (C_{sorbed, pooled} and Flux_{sorb, pooled} for sorbed sample concentrations and fluxes, respectively) were compared to average values of all four replicates from the grab sampling methodologies (C_{grab, average} and Flux_{grab, average} for grab sample concentrations and fluxes, respectively).

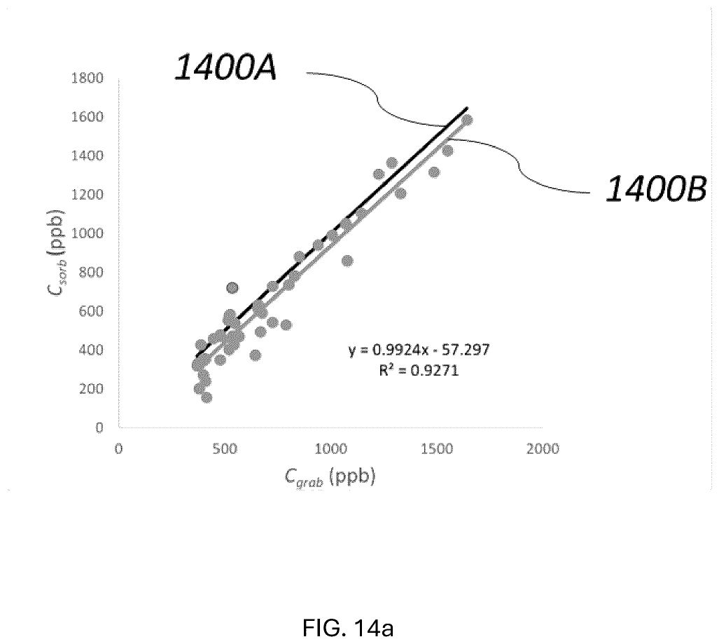

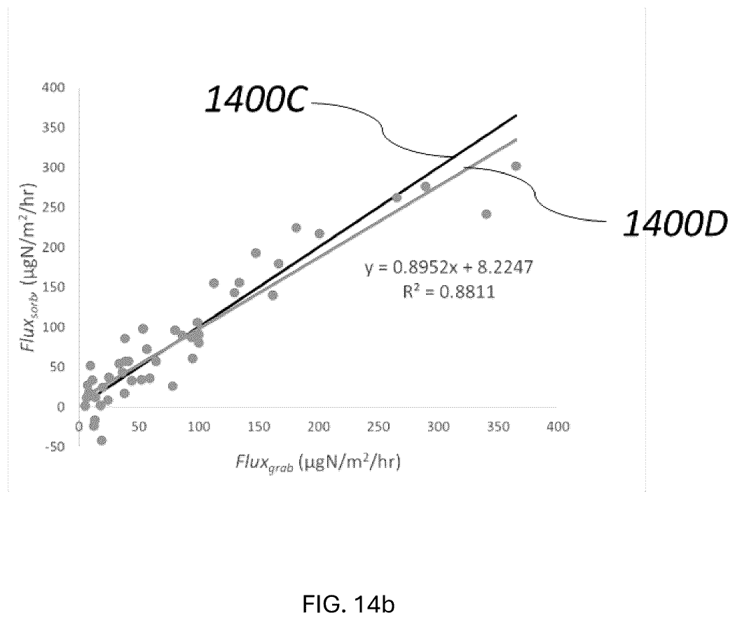

Results: FIG. 14a is a graph of single sample results for soil gas concentrations (ppb) at 30 minutes of a chamber deployment, and FIG. 14b is a graph of the corresponding soil gas fluxes (μgN/m²/hr) of FIG. 14a. The least squares linear fit is shown, together with the regression coefficient (R²). In FIG. 14a, line 1400A represents an ideal curve (a 1:1 relationship) between both methods for reference. Line 1400B compares the concentrations measured by the USDA in the x-axis vs the values measured by E-Flux in our lab in the y-axis. In FIG. 14b, line 1400C represents an ideal curve (a 1:1 relationship) between both methods for reference. Line 1400D compares the fluxes measured by the USDA in the x-axis vs the values measured by E-Flux in our lab in the y-axis.

Grab sample concentrations at the end of the chamber deployment (30 minutes for the standard grab samples) were compared to those of the 400 mL large sorbent-based samples and field-stabilized in a sorbent cartridge) by reg. Using linear interpolation between the time zero concentration and the actual measured concentration, the sorbent-based concentration was corrected to 30 minutes, due to the time delay (typically less than 3 minutes) between the last grab sample and the sorbent sample. FIGS. 14a and 14b show a comparison between grab sampling results and those based on sorbent sampling results. Gas sample concentrations are in ppb v/v N₂O (FIG. 14a), while N₂O soil gas fluxes are in units of μgN/m²/hr (FIG. 14b).

Although 48 individual chamber deployments were done, two sorbent-based samples were lost, resulting in 46 paired observations between both sampling methods. These results include 46×3=138 grab samples, compared to 60 sorbed samples (46 sorbed samples at 30 minutes, 12 time zero sorbed samples, and 12 travel blanks resulting from one triplicate set for each day of sampling).

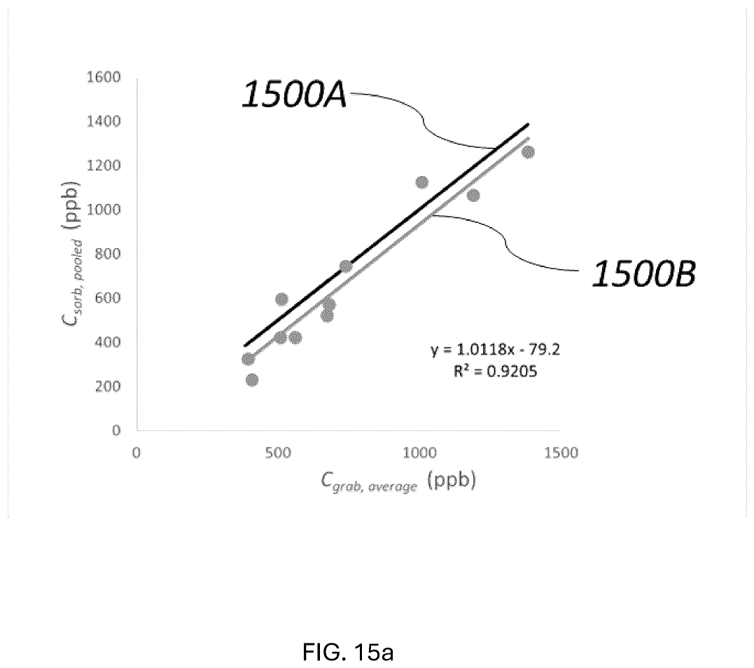

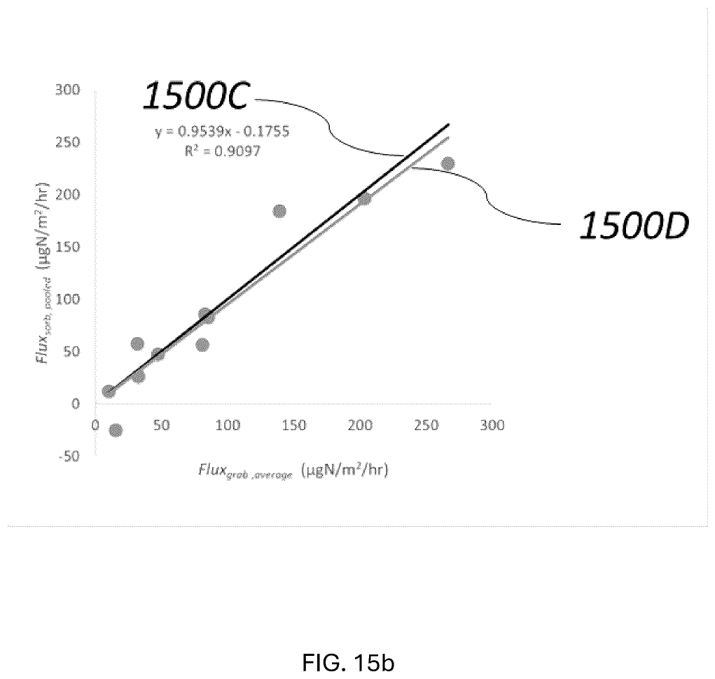

FIG. 15a is a graph of pooled sample results for soil gas concentrations (ppb) at 30 minutes of chamber deployment compared to average grab sample results (ppb). FIG. 15b is a graph of the resulting soil gas fluxes from both techniques (μgN/m²/hr) from FIG. 15a. FIG. 15a shows pooled sampling results (in which 100 mL for each four N treatment replicates each day were sampled and added to a single sorbent cartridge). Units are as those in FIG. 14a. These were compared to the average results for the corresponding standard grab sampling results for all four of the same sample replicates. FIG. 15a shows concentrations at the end of the chamber deployment, while FIG. 15b shows N₂O soil gas fluxes based on both methodologies. In FIG. 15a, line 1500A represents an ideal curve (a 1:1 relationship) between both methods for reference. Line 1500B compares the concentrations measured by the USDA in the x-axis vs the values measured by E-Flux in our lab in the y-axis. In FIG. 15b, line 1500C represents an ideal curve (a 1:1 relationship) between both methods for reference. Line 1500D compares the fluxes measured by the USDA in the x-axis vs the values measured by E-Flux in our lab in the y-axis. Although 12 pooled chamber samples were collected, one sorbent sample was lost, resulting in 11 paired observations between both sampling methods. These results include 47×3 samples taken per chamber deployment=141 grab samples, shown as average of four replicates, compared to 35 sorbed samples (11 sorbed pooled samples at 30 minutes, 12 time zero sorbed samples, and 12 travel blanks, one set of triplicates each day of sampling).

Line 1400A (FIG. 14a) and line 1500A (FIG. 15a) are ideal lines for Gas Concentrations, these represent lines if the results of both analyses were identical. Line 1400A (FIG. 14a) and line 1500A (FIG. 15a) are the results of the USDA analysis in the x-axis against the same values in the y-axis. Lines 1400B (FIGS. 14a) and 1500B (FIG. 15a) compare the concentrations measured by the USDA in the x-axis vs the values measured by E-Flux in our lab in the y-axis. FIG. 14a and FIG. 15a represent similar ideas (ideal behaviors vs. the comparison of both measured values) for concentrations. FIG. 14b and FIG. 15b represent similar ideas (ideal behaviors vs. the comparison of both measured values) for fluxes (not concentrations, as in FIGS. 14a and 15a).

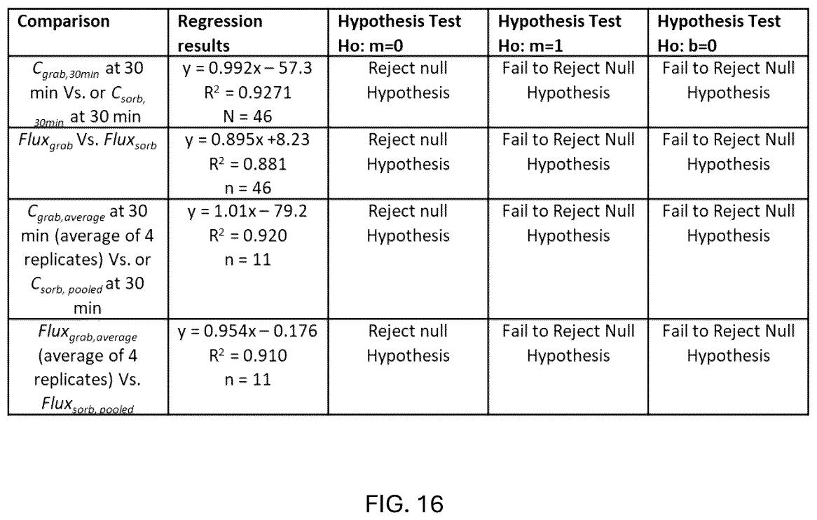

Two-tailed statistical tests were conducted on these regressions (with a 95% significance level, or α/2=0.025): a) for the significance level of the regression, b) if the slope was significantly different to an ideal, 1:1 plot (Ho:m=1), and c) if the intercept was significantly different to an ideal, 1:1 plot (Ho:b=0). The results of these tests on the regressions (for both N₂O concentrations and soil gas fluxes) are summarized in the table in FIG. 16.

FIG. 16 is table of a comparison of grab sampling results (independent variable, either C_{grab} or Flux_{grab}) and sorbent-based sampling results (dependent variable, either C_{sorb} or Flux_{sorb}). All hypotheses tests for slope (m) and intercept (b) shown had a 95% significance level (α=0.5). Nitrous oxide gas concentrations (either C_{grab} or C_{sorb}, in N₂O ppb) are those towards the end of the chamber deployment (30 minutes). Fluxes (either Flux_{grab} or Flux_{sorb}) are in the units of μgN/m²/hr. Pooled sampling results for sorbent-based samples (C_{sorb, pooled} or Flux_{sorb, pooled}) in which all four nitrogen treatment replicates were sorbed on the same cartridge were compared with the average results for all four replicate grab sample results (C_{grab, average} or Flux_{grab, average}).

Discussion: There was close agreement between the results of the grab sampling concentrations and fluxes and those based on the standard grab sampling USDA methodology, as indicated by the quality of the regressions (high regression coefficients), as well as the hypotheses tested (the regressions were significant and not found to be significantly different than those of a 1:1 ideal relationship, for both slope and intercept). It is noted that the sorption-based results show larger variability at low concentrations. For example, some concentrations in the 400-500 ppb range by the grab sampling analysis showed a 150-600 ppb range for the sorption-based sampling. Once these gas concentrations were used to calculate fluxes, this translated into larger flux variability of the sorption-based sampling at low flux range than the results of the standard grab sampling procedure. For example, fluxes in the 0-40 μgN/m²/hr obtained with the grab sampling procedure corresponded to a range of −50 to 100 μgN/m²/hr. The variability of the sorbent-sampling data seemed to be reduced at higher concentration and flux levels. Given that the sorbent-based procedure requires significantly fewer number of samples, this is notable.

These results suggest that both methods are equivalent at most of the range, although higher uncertainty might be introduced by the sorption-based method at lower fluxes (and gas concentrations). The sorption-based method is still useful despite this added uncertainty at low fluxes, as the main drivers of long-term fluxes seem to be large events (spikes) caused by irrigation, precipitation and/or fertilization. For example, it has been found that over a period of over 2 years, 15% of the high flux measurements account for 75% of the total emissions. Furthermore, the sorption-based method may be made more sensitive by increasing the sample volume, reducing the baseline N₂O signal in clean (blank) sorbent, and/or using more sensitive detectors for N₂O than the MS used (for example electron capture detectors, or ECD are known to be more sensitive to this gas than the MS method used for sorbed samples).

The results of the pooled sample analysis were also promising. Compared to the regressions of single chamber deployment (FIGS. 14a and 14b), both pooled concentrations and soil gas fluxes showed improvements (FIGS. 15a and 15b, R²=0.920 and R²=0.910, respectively). This suggests that the error in the single measurement sorbent-based fluxes (FIG. 14b) was randomly distributed around the average value for the four nitrogen treatment replicates sampled each day. This finding opens the option to significantly further reduce the number of samples taken while preserving the quality of the flux measurement. Compared to grab sampling, sorbent sampling required much fewer samples. In this example, this reduction of samples enabled by the sorbent method was approximately more than two times (2×) for single chamber deployments, and by nearly four times (4×) for pooled sorbent samples (in which four field samples from equal number of chamber deployments were sorbed into the same cartridge).

Although N₂O emissions are not currently regulated, there is growing interest in accounting for them in carbon credit markets. If these were to function under regulatory-type criteria, in which GHG emitters need to prove they do not exceed critical thresholds (a one-tailed test), a small bias might be tolerable. Both regressions of soil gas fluxes obtained with single chamber deployment and pooled samples show that the sorbent-based method has a slight bias. However, the hypothesis tests conducted show that this bias is not significant (α=0.05).

This work shows that use of sorbents for sampling soil gas flux chambers results in data of similar quality as the data obtained by traditional grab sampling methodologies. This improvement has important implications, as sorbent sampling has shown multiple benefits in other areas. A major benefit may be extended sample life, as well as others, as illustrated by pooling multiple samples into a single cartridge that results in a reduction of nearly 4 times the number of samples compared to traditional grab sampling. These results illustrate the potential of sorbent-based sampling to the measurement of N₂O soil emissions.

Although the embodiments have been described with reference to the drawings and specific examples, it will readily be appreciated by those skilled in the art that many modifications and adaptations of the apparatuses and processes described herein are possible without departure from the spirit and scope of the embodiments as claimed hereinafter. Thus, it is to be clearly understood that this description is made only by way of example and not as a limitation on the scope of the embodiments as claimed below.

For the foregoing reasons, the subject matter described herein provides innovative apparatus, systems, and methods for absorbing gas from a ground source and measuring gas fluxes. The current system may be modified in multiple ways and applied in various technological applications. The disclosed apparatus, systems, and methods may be modified and customized as required by a specific operation or application, and the individual components may be modified and defined, as required, to achieve the desired result.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed in this specification are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the implied term “about.” The (stated or implied) term “about” indicates that a numerically quantifiable measurement is assumed to vary by as much as 30 percent, but preferably by at least 10%. Essentially, as used herein, the term “about” refers to a quantity, level, value, or amount that varies by as much 10% to a reference quantity, level, value, or amount. Accordingly, unless otherwise indicated, the numerical properties set forth in the following specification and claims are approximations that may vary depending on the desired properties sought to be obtained in embodiments of the present invention.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein. The term “an effective amount” as applied to a component or a function excludes trace amounts of the component, or the presence of a component or a function in a form or a way that one of ordinary skill would consider not to have a material effect on an associated product or process.

What is claimed is:

1. An apparatus for absorbing a gas, the apparatus comprising:
a cartridge, the cartridge comprising:
a housing having a top end opposite a bottom end;
a first gas absorbing material disposed within the housing;
a second gas absorbing material disposed within the housing; and
a top end cap, wherein the top end of the housing is capable of forming a gas-tight coupling with the top end cap.

2. The apparatus of claim 1, wherein the bottom end of the housing has an opening capable of receiving a tube.

3. The apparatus of claim 2, further comprising a bottom end cap, wherein the bottom end of the housing is capable of forming a gas-tight coupling with the bottom end cap.

4. The apparatus of claim 2, wherein the housing further comprises a first element and a second element;
wherein the first element is separable from the second element; and
wherein the first gas absorbing material is disposed within the first element, and the second gas absorbing material is disposed within the second element.

5. The apparatus of claim 4, wherein the first element has a first element top end and first element bottom end;
the second element has a second element top end and a second element bottom end;
wherein the first element bottom end is separably coupled to the second element top end;
and wherein the first element bottom end forms a gas-tight coupling to the second element top end.

6. The apparatus of claim 5, wherein the first element bottom end is separably coupled to the second element top end by a gas-tight connector, where a top end of the gas-tight connector is coupled to the first element bottom end and a bottom end of the gas-tight connector is coupled to the second element top end.

7. The apparatus of claim 2, further comprising a gas porous separation layer disposed between the first gas absorbing material and the second gas absorbing material.

8. The apparatus of claim 7, wherein the cartridge has a first gas permeable support layer between the first gas absorbing material and the gas porous separation layer; and
wherein the cartridge has a second gas permeable support layer between the second gas absorbing material and the gas porous separation layer.

9. The apparatus of claim 6, wherein the second element bottom end has a reducer connector;
wherein the reducer connector is capable of receiving a tube; and
wherein the reducer connector creates a gas-tight connection between the tube and the second element.

10. The apparatus of claim 1, wherein the first gas absorbing material is a nitrous oxide sorbent.

11. The apparatus of claim 1, wherein the cartridge is made of metal.

12. The apparatus of claim 7, wherein the separation layer is glass wool.

13. The apparatus of claim 1, further comprising:
a cooling element coupled to the cartridge.

14. The apparatus of claim 2, further comprising:
a syringe, the syringe having a barrel and a plunger, the plunger operable to displace a gas within the barrel; and
wherein the syringe is in gaseous communication with the cartridge such that the gas is capable of being transferred from the syringe to the cartridge.

15. The apparatus of claim 14, further comprising a tube, the tube having a first tube end and a second tube end, the first tube end in gaseous communication with the syringe and the second tube end in gaseous communication with the cartridge.

16. The apparatus of claim 15, further comprising a syringe pump operably connected to the syringe, wherein the syringe pump is capable of pushing the plunger into the barrel of the syringe to expel the gas from the syringe through the tube and into the cartridge such that the gas is absorbed by the second gas absorbing material; and
wherein the syringe pump is capable of expelling the gas from the syringe at a constant rate.

17. The apparatus of claim 16, wherein the pump is capable of supporting a plurality of syringes, and wherein the pump is capable of deploying gas from the plurality of syringes into the cartridge.

18. The apparatus of claim 15, wherein the tube is made of vinyl.

19. A system for absorbing a gas from a ground source, comprising:
a chamber having a top portion and a bottom portion, the bottom portion having an opening in one end, the opening exposed to gas emanating from the ground source;
a support structure disposed within the chamber;
a gas absorbing material supported by the support structure, wherein the gas absorbing material is in gaseous communication with the ground source; and
wherein the chamber is sealed from ambient air when the opening of the bottom portion is placed in gaseous communication with the ground source.

20. A method for absorbing a gas from a ground source, the method comprising the steps of:
collecting a gas in a chamber;
sampling the gas in the chamber to form a gas sample; and
stabilizing the gas sample to form a stabilized gas sample.

21. The method of claim 20, further comprising the step of:
circulating the gas within the chamber.

22. The method of claim 20, further comprising the step of:
cooling the stabilized gas sample.

23. The method of claim 20, further comprising the step of:
calculating a gas flux from the stabilized gas sample.

24. The method of claim 20, wherein sampling the gas comprises absorbing the gas sample with a sorbent in the chamber.

25. The method of claim 20, wherein sampling the gas comprises extracting a gas sample from the chamber with a syringe.

26. The method of claim 25, wherein stabilizing the gas sample comprises injecting the gas sample from the syringe to a cartridge;
wherein the cartridge comprises:
a housing having a top end opposite a bottom end;
a first gas absorbing material disposed within the housing;
a second gas absorbing material disposed within the housing; and
a gas porous separation layer disposed between the first gas absorbing material and the second gas absorbing material.

27. The method of claim 24, wherein stabilizing the gas sample comprises placing the sorbent in a cartridge and sealing the cartridge from ambient air.

28. The method of claim 21, wherein a fan is disposed in the chamber.

29. The method of claim 21, wherein sampling the gas in the chamber to form a gas sample is automated and performed continuously to reduce biases caused by gas accumulation within the chamber.

30. The method of claim 21, wherein a pump is in gaseous communication with the chamber;
wherein a cartridge is in gaseous communication with the pump and the chamber;
wherein the cartridge comprises:
a housing having a top end opposite a bottom end; and
a first gas absorbing material disposed within the housing.
